(19) United States
(12) Patent Application Publication
(10) Pub. No.: US 2017/0075419 A1
(43) Pub. Date: Mar. 16, 2017

(54) SYSTEM AND METHOD FOR REDUCING EYE STRAIN OF A USER OPERATING A DISPLAY DEVICE

(71) Applicant: HCL Technologies Limited, Uttar Pradesh (IN)

(72) Inventor: Vijay Tiruchengode PARTHASARATHY, Chennai (IN)

(21) Appl. No.: 15/241,776

(22) Filed: Aug. 19, 2016

(30) Foreign Application Priority Data
Sep. 16, 2015 (IN) 2924/DEL/2015

(51) Int. Cl. G06F 3/01; G09B 19/00; G06F 3/00

(52) U.S. Cl. CPC G06F 3/013; G06F 3/005; G09B 19/003

(57) ABSTRACT

The present disclosure relates to system(s) and method(s) for reducing eye strain of a user viewing a display is illustrated. The system is configured for monitoring eyes of a user operating the display to capture gaze data of the user and analyzing the gaze data to determine an eye blink rate and an eye movement rate. Once the gaze data is analyzed, in the next step, the system is configured for determining abnormality in the eyes using a normal eye blink threshold range and a normal eye movement threshold range. Further, the method comprises recommending to the user, over the display, one or more eye blinking exercises or eye movement exercises based on the abnormality in the eyes, thereby facilitating reduction of eyestrain of the user.

### CROSS-REFERENCE TO RELATED APPLICATIONS AND PRIORITY

The present application claims the benefit from Indian Complete Patent Application No. 2924/DEL/2015, filed on Sep. 16, 2015, the entirety of which is hereby incorporated by reference.

### TECHNICAL FIELD

The present disclosure in general relates to a display device. More particularly, the present invention relates to a display device for reducing eye strain.

### BACKGROUND

Now-a-days, electronic display devices are widely used across the world for viewing information, reading books, writing and other visualization applications. Since, display devices are dynamic in nature; they can be used to browse through large amount of information. However, in most of cases eye strain or eye fatigue is caused by prolong use of electronic displays. While viewing the electronic display, the eye muscle usage is restricted in a particular direction resulting into muscle failure in some cases. A tendency to blink less often when staring at a digital screen affects the dryness of the eyes and leads to increased strain level further damaging the eyes. Also gazing for long periods at digital devices such as Television, Computer screens, Smart phones, kindle and Gaming Console results into further damage to eyes.

The present methods in the art for addressing eye strain level provide solution for post eye strain treatment, like exercise for the eyes. Some of the other solutions are configured only for computer monitor fixed externally to provide exercise for the eyes. But these solutions are not available as a background application in all the digital devices and lag real time solution to monitor the eye strain level.

### SUMMARY

This summary is provided to introduce aspects related to systems and methods for reducing eye strain of a user viewing a display and the aspects are further described below in the detailed description. This summary is not intended to identify essential features of the claimed subject matter nor is it intended for use in determining or limiting the scope of the claimed subject matter.

In one embodiment, a system for reducing eye strain of a user viewing a display of the system is illustrated. The system comprises a memory and a processor coupled to the memory, wherein the processor is configured for executing programmed instructions stored in the memory for monitoring eyes of a user operating a display to capture gaze data of the user. Further, the processor is configured for analyzing the gaze data to determine an eye blink rate and an eye movement rate of the user. In the next step, the processor is configured for determining abnormality in the eyes. The abnormality in the eyes is detected if the eye blink rate is not within a normal eye blink threshold range or if the eye movement rate is not within a normal eye movement threshold range. Further, the processor is configured for recommending to the user over the display, one or more eye blinking exercises from a predefined set of eye blinking exercises if the eye blink rate is not within the normal eye blink threshold range or one or more eye movement exercises from a predefined set of eye movement exercises if the eye movement rate is not within the normal eye movement threshold range, thereby facilitating reduction of eyestrain of the user.

In one embodiment, a method for reducing eye strain of a user viewing a display of the system is illustrated. The method comprises monitoring eyes of a user operating a display to capture gaze data of the user. Further, the method comprises analyzing the gaze data to determine an eye blink rate and an eye movement rate. Once the gaze data is analyzed, in the next step, the method comprises determining abnormality in the eyes if the eye blink rate is not within a normal eye blink threshold range or if the eye movement rate is not within a normal eye movement threshold range. Further, the method comprises recommending to the user, over the display, one or more eye blinking exercises from a predefined set of eye blinking exercises if the eye blink rate is not within the normal eye blink threshold range or one or more eye movement exercises from a predefined set of eye movement exercises if the eye movement rate is not within the normal eye movement threshold range, thereby facilitating reduction of eyestrain of the user.

In one embodiment, a computer program product having embodied computer program for reducing eye strain of a user viewing a display is disclosed. The program comprises a program code for monitoring eyes of a user operating a display to capture gaze data of the user. The program further comprises a program code for analyzing the gaze data to determine an eye blink rate and an eye movement rate of the user's eyes. The program further comprises a program code for determining abnormality in the eyes if the eye blink rate is not within a normal eye blink threshold range or if the eye movement rate is not within a normal eye movement threshold range. The program further comprises a program code for recommending to the user, over the display, one or more eye blinking exercises from a predefined set of eye blinking exercises if the eye blink rate is not within the normal eye blink threshold range or one or more eye movement exercises from a predefined set of eye movement exercises if the eye movement rate is not within the normal eye movement threshold range, thereby facilitating reduction of eyestrain of the user.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for reducing eye strain of a user viewing a display, in accordance with an embodiment of the present subject matter.

FIG. 2 illustrates the system for reducing eye strain of a user viewing a display, in accordance with an embodiment of the present subject matter.

FIG. 3 illustrates a flowchart to enable the system for reducing eye strain of a user viewing a display, in accordance with an embodiment of the present subject matter.

### DETAILED DESCRIPTION

The present subject matter relates to a system for reducing eye strain of a user viewing a display of the system. The system comprises a memory and a processor coupled to the memory, wherein the processor is configured for executing programmed instructions stored in the memory for monitoring eyes of a user operating the display to capture gaze data of the user. In one embodiment, the system may be connected to a video or image display devices like Television, PC, Smart-phones, kindle and Gaming Console over a communication network. In one embodiment, the system configured and running in a video or image display devices like Television, PC, Smart-phones, kindle and Gaming Console. In one embodiment, the system is configured to access a camera or wired/wireless eye blink sensing device present in the display devices. Further, the system is configured to monitor the user's eye continuously for a particular amount of time when the display is active and capture the gaze data of the user. Once the gaze data is captured, the system analyses the gaze data to determine an eye blink rate and an eye movement rate of the user's eyes.

In the next step, the system determines if the user's eye blink rate is within a predefined eye blink threshold range. In case if the eye blink rate is not within the predefined eye blink threshold range, the system provides alerts/warning to the user in the form of audio or visual instructions on the display and suggests one or more eye blinking exercises from a predefined set of eye blink exercises stored in the system. Further, the system is configured to analyse the gaze data to identify the eye movement rate and determine the less and not used eye muscles such as Superior Rectus (SR), Inferior Rectus (IR), Medial Rectus (MR), Lateral Rectus (LR), Superior Oblique (SO), and Inferior Oblique (IO). If the eye movement rate is not within the normal eye movement threshold range corresponding to each eye muscle, the system is configured to suggest to the user, one or more eye movement exercises from a predefined set of eye movement exercises, thereby facilitating reduction of eyestrain of the user. The predefined set of eye movement exercises is represented in table 1.

TABLE 1
predefined set of eye movement exercises.

| Sr. | | |
|---|---|---|
| No. | Exercise | Eye Muscle |
| 1 | Up and Down Gaze | Superior Rectus, Inferior Rectus |
| 2 | Left and Right Gaze | Medial Rectus, Lateral Rectus |
| 3 | Bottom Right and Bottom | Superior Oblique, Inferior Rectus |
| | Left Gaze | |
| 4 | Top Right and Top Left Gaze | Inferior Oblique, Superior Rectus |
| 5 | Right Gaze | Medial Rectus, Lateral Rectus |
| 6 | Left Gaze | Medial Rectus, Lateral Rectus |

In one embodiment, the movement of the eyes in a particular direction is determined based on the gaze data for a predefined interval. More specifically, the system determines the eye muscles that are used the least by analysing the gaze data. Further, based on the eye muscle usage data, the system may suggest one or more exercises from table 1 in order to reduce the strain on the eyes.

While aspects of described system and method for reducing eye strain of a user viewing a display may be implemented in any number of different computing systems, environments, and/or configurations, the embodiments are described in the context of the following exemplary system.

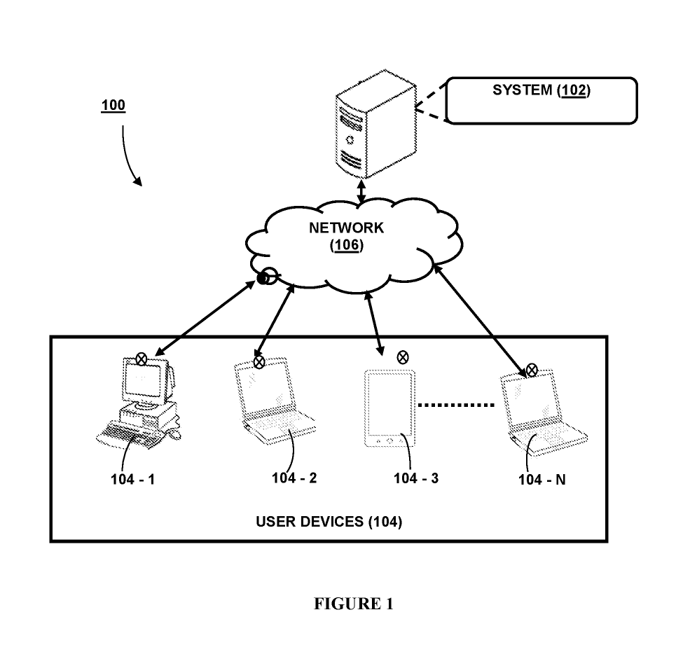

Referring now to FIG. 1, a network implementation 100 of a system 102 for reducing eye strain of a user viewing a display in the system is disclosed, wherein the display may be a video or image display devices like Television, PC, Smart-phones, kindle and Gaming Console. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more display's connected to the system 102, hereafter user devices 104-1, 104-2 . . . 104-N, collectively referred to as user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

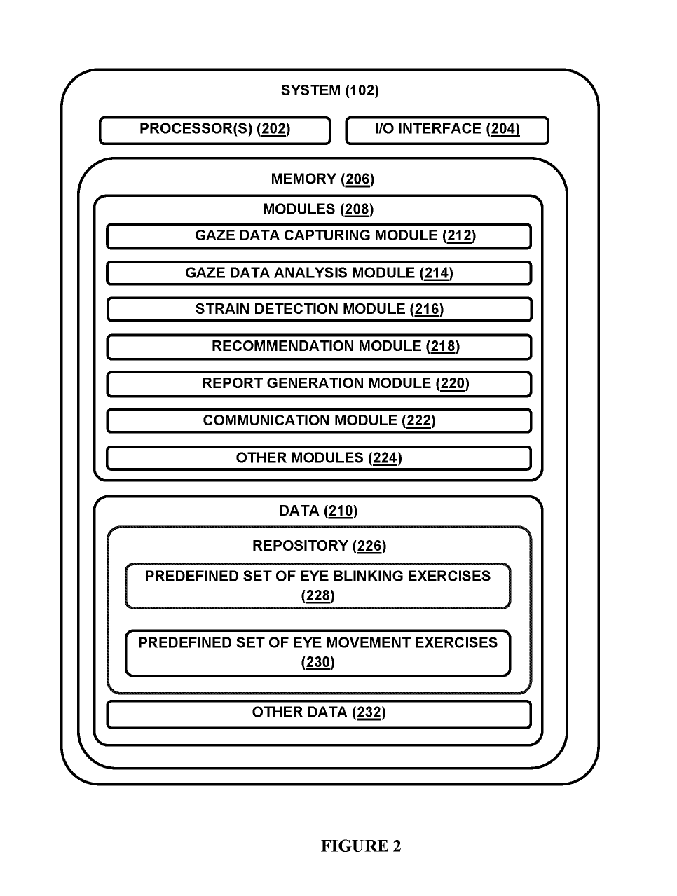

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a gaze data capturing module 212, a gaze data analysis module 214, a strain detection module 216, a recommendation module 218, a report generation module 220, a communication module 222, and other modules 224. The other modules 224 may include programs or coded instructions that supplement applications and functions of the system 102.

The data 210, amongst other things, serves as a repository for storing data processed, received, and generated by one or more of the modules 208. The data 210 may also include a repository 226, and other data 232. In one embodiment, the repository 226 may be configured to store a predefined set of eye blinking exercises 228 and a predefined set of eye movement exercises 230. The set of eye blinking exercises 228 and a predefined set of eye movement exercises 230 may be recommended to the user in order to reduce the eye strain on the user's eyes. In one embodiment, the other data 232 may include data generated as a result of the execution of one or more modules in the other module 224.

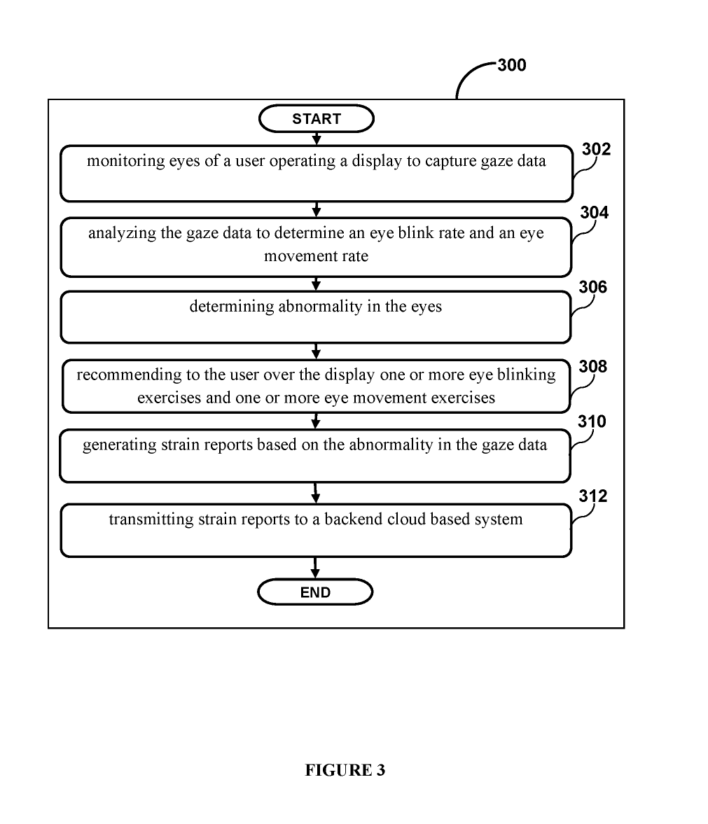

In one implementation, a user may use the user device 104 to perform routing operations such as reading books, browsing internet, writing notes and the like. In one embodiment, the gaze data capturing module 212 is configured to receive gaze data of the user from a camera or a wired/wireless eye blink sensing device connected to the user device 104, if the user is performing his routine work over the user device 104. In one embodiment, the wired/wireless eye blink sensing device may be connected to the user device 104 through a wired connection, Bluetooth, Wi-Fi, NFC or any other wired or wireless communication channel. Further, the gaze data analysis module 214 is configured for analyzing the gaze data and determining an eye blink rate and an eye movement rate of the user's eyes. Once the gaze data is analyzed, in the next step, the strain detection module 216 is configured to determine abnormality in the eyes if the eye blink rate is not within a normal eye blink threshold range or if the eye movement rate is not within a normal eye movement threshold range. Further, the recommendation module 218 is configured to recommend one or more eye blinking exercises from a predefined set of eye blinking exercises to the user, over the display, if the eye blink rate is not within the normal eye blink threshold range. In one embodiment, the normal eye blink threshold range may be considered as 18 blinks on an average. Further, the recommendation module 218 is also configured to recommend one or more eye movement exercises from a predefined set of eye movement exercises, to the user over the display, if the eye movement rate is not within the normal eye movement threshold range, thereby facilitating reduction of eyestrain of the user. Further, the report generation module 220 is configured to generate strain reports based on the observations made by the gaze data analysis module 216. Once these strain reports are generated, in the next step, the communication module 222 is configured to transfer the strain reports to a backend cloud system for further analysis. In one embodiment, the backend cloud system may be accessed by patient, physicians and insurance agencies to analyse the strain reports for different applications. The physicians may use the strain reports to recommend treatments to the user, whereas the insurance agencies may use the strain reports to determine premium amount of the user's insurance. The process for reducing eye strain of a user viewing a display of system 102 is further elaborated with respect to the flow chart of FIG. 3.

Referring now to FIG. 3, a method 300 for reducing eye strain of a user viewing a display connected to the system 102 is illustrated, in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, the gaze data capturing module 212 is configured to determine if the user is active on the user device 104. If the user is performing his routine work over the user device 104, the gaze data capturing module 212 is configured to receive gaze data of the user from a camera or a wired/wireless eye blink sensing device connected to the user device 104.

At block 304, the gaze data analysis module 214 is configured for analyzing the gaze data and determining an eye blink rate and an eye movement rate of the user's eyes.

At block 306, once the gaze data is analyzed, in the next step, the strain detection module 216 is configured to determine abnormality in the eyes if the eye blink rate is not within a normal eye blink threshold range or if the eye movement rate is not within a normal eye movement threshold range.

At block 308, the recommendation module 218 is configured to recommend one or more eye blinking exercises from a predefined set of eye blinking exercises to the user, over the display, if the eye blink rate is not within the normal eye blink threshold range. Further, the recommendation module 218 is also configured to recommend one or more eye movement exercises from a predefined set of eye movement exercises to the user over the display, if the eye movement rate is not within the normal eye movement threshold range, thereby facilitating reduction of eyestrain of the user.

At block 310, the report generation module 220 is configured to generate strain reports based on the observations made by the gaze data analysis module 216.

At block 312, once the strain reports are generated, in the next step, the communication module 222 is configured to transfer the strain reports to a backend cloud system for further analysis. In one embodiment, the backend cloud system may be accessed by patient, physicians and insurance agencies to analyse the strain reports for different applications. The physicians may use the strain reports to recommend treatments to the user, whereas the insurance agencies may use the strain reports to determine premium amount of the user's insurance.

Although implementations for methods and systems for reducing eye strain of a user viewing a display have been described, it is to be understood that the appended claims are not necessarily limited to the specific features or methods described. Rather, the specific features and methods are disclosed as examples of implementations for reducing eye strain of a user viewing a display.

We claim:

1. A system for reducing eye strain of a user viewing a display of the system, the system comprising:
a memory; and
a processor coupled to the memory, wherein the processor is configured to execute a set of instructions stored in the memory for:
monitoring eyes of a user operating a display to capture gaze data of the user;
analysing the gaze data to determine an eye blink rate and an eye movement rate;
determining abnormality in the eyes if the eye blink rate is not within a normal eye blink threshold range or if the eye movement rate is not within a normal eye movement threshold range; and
recommending to the user over the display,
one or more eye blinking exercises from a predefined set of eye blinking exercises if the eye blink rate is not within the normal eye blink threshold range or
one or more eye movement exercises from a predefined set of eye movement exercises if the eye movement rate is not within the normal eye movement threshold range, thereby facilitating reduction of eyestrain of the user.

2. The system of claim 1, wherein the gaze data is captured by a camera or a wired/wireless eye blink sensing device connected to the display.

3. The system of claim 1, further comprising recommending one or more eye movement exercises based on eye muscles usage, wherein the eye muscles usage is determined based on movement of the eyes along x-axis, y-axis, and z-axis, wherein the movement of the eyes along x-axis, y-axis, and z-axis is determined from the gaze data, and wherein the eye muscles include a Superior Rectus (SR), an Inferior Rectus (IR), a Medial Rectus (MR), a Lateral Rectus (LR), a Superior Oblique (SO), an Inferior Oblique (IO).

4. The system of claim 1, wherein the eye blinking exercises and the eye movement exercises are suggested in the form of audio and/or visual instructions, on the display, to blink eyes or move eyes towards a particular direction.

5. A method for reducing eye strain of a user viewing a display, the method comprising:
monitoring, by a processor, eyes of a user operating a display to capture gaze data of the user;
analysing, by the processor, the gaze data to determine an eye blink rate and an eye movement rate;
determining, by the processor, abnormality in the eyes if the eye blink rate is not within a normal eye blink threshold range or if the eye movement rate is not within a normal eye movement threshold range; and
recommending, by the processor, to the user over the display,
one or more eye blinking exercises from a predefined set of eye blinking exercises if the eye blink rate is not within the normal eye blink threshold range or
one or more eye movement exercises from a predefined set of eye movement exercises if the eye movement rate is not within the normal eye movement threshold range, thereby facilitating reduction of eyestrain of the user.

6. The method of claim 5, wherein the gaze data is captured by a camera or a wired/wireless eye blink sensing device connected to the display.

7. The method of claim 5, further comprising recommending one or more eye movement exercises based on eye muscles usage, wherein the eye muscles usage is determined based on movement of the eyes along x-axis, y-axis, and z-axis, wherein the movement of the eyes along x-axis, y-axis, and z-axis is determined from the gaze data, and wherein the eye muscles include a Superior Rectus (SR), an Inferior Rectus (IR), a Medial Rectus (MR), a Lateral Rectus (LR), a Superior Oblique (SO), an Inferior Oblique (IO).

8. The method of claim 5, wherein the eye blinking exercises and the eye movement exercises are suggested in the form of audio and/or visual instructions, on the display, to blink eyes or move eyes towards a particular direction.

9. A computer program product having embodied thereon a computer program for reducing eye strain of a user viewing a display, the computer program product comprising:
a program code for monitoring eyes of a user operating a display to capture gaze data of the user;
a program code for analysing the gaze data to determine an eye blink rate and an eye movement rate;
a program code for determining abnormality in the eyes if the eye blink rate is not within a normal eye blink threshold range or if the eye movement rate is not within a normal eye movement threshold range; and
a program code for recommending to the user over the display,
one or more eye blinking exercises from a predefined set of eye blinking exercises if the eye blink rate is not within the normal eye blink threshold range or
one or more eye movement exercises from a predefined set of eye movement exercises if the eye movement rate is not within the normal eye movement threshold range, thereby facilitating reduction of eyestrain of the user.
